(19) United States
(12) Patent Application Publication
(10) Pub. No.: US 2017/0339152 A1
(43) Pub. Date: Nov. 23, 2017

(54) COMPUTING DEVICE CONFIGURATION CHANGE MANAGEMENT VIA GUEST KEYS

(71) Applicant: Lenovo Enterprise Solutions (Singapore) PTE. LTD., New Tech Park (SG)

(72) Inventors: Fred Allison Bower, III, Durham, NC (US); Scott Kelso, Cary, NC (US); Gregory B. Pruett, Raleigh, NC (US); Christopher Landon Wood, Chapel Hill, NC (US)

(21) Appl. No.: 15/160,769

(22) Filed: May 20, 2016

(51) Int. Cl. H04L 29/06; H04L 9/32; H04L 9/30; H04L 12/24; H04L 9/14

(52) U.S. Cl. CPC H04L 63/101; H04L 63/06; H04L 41/0813; H04L 9/14; H04L 9/30; H04L 9/3247

(57) ABSTRACT

A selected guest key for making configuration changes to a computing device in a current use period of the computing device by an end user to which the selected guest key has been provided is activated. The end user presenting the selected guest key when remotely logging onto the computing device from a remote client computing device is authenticated. Responsive to authentication of the end user, the end user is permitted to make the configuration changes to the computing device via communications from the remote client computing device that are encrypted or signed with the selected guest key. Upon expiration of the current use period, the selected guest key is deactivated, and a new selected guest key for making configuration changes in another current use period by a different end user to which the new selected guest key has been provided can be activated.

### BACKGROUND

Traditionally, organizations such as corporations hosted computing devices like servers at locations under the control of the organizations. For example, a company may have purchased or leased a number of servers, and located them in a server room at the same location as the company's other assets, including its human resources, or at an offsite location under the control of the company. However, computing needs can be variable, which means that many times organizations have had to purchase or lease more servers than what they typically needed, to accommodate peak utilization.

More recently, cloud computing topologies such as infrastructure as a service (IaaS) and platform as a service (PaaS) have become available. An organization may be able to rent or lease a portion of a computing device like a server, or the complete computing device, for a period of time ranging from days to weeks or even months or longer. The computing device remains physically located at the facilities of a service provider, and a company or other customer of the provider accesses the device over the Internet. This means that the company can more closely size the computing resources it leases with the company's current computing needs.

### SUMMARY

An example method includes activating, via firmware of a computing device, a selected guest key for making configuration changes to the computing device in a current use period of the computing device by an end user to which the selected guest key has been provided. The method includes authenticating, via the firmware, the end user presenting the selected guest key when remotely logging onto the computing device from a remote client computing device. The method includes, responsive to authentication of the end user, permitting, via the firmware, the end user to make the configuration changes to the computing device via communications from the remote client computing device that are encrypted or signed with the selected guest key.

An example non-transitory computer-readable data storage medium stores computer-executable code executable by firmware of a computing device. The code is executable by the firmware to receive a request to retrieve an existing value for a configuration parameter of the computing device from a remote client computing device operated by an end user, the request encrypted or signed with a guest public key. The code is executable by the firmware to determine whether the guest public key matches a currently enabled guest private key of a number of guest private keys installed on the computing device. The code is executable by the firmware to, in response to determining that the guest public key matches the currently enabled guest private key, determine whether the existing value is one of: a default value for the configuration parameter, a value for the configuration parameter provided by the end user, and a value for the configuration parameter provided by a prior end user via a different guest public key matching a currently disabled guest public key of the guest public keys. The code is executable by the firmware to, in response to determining that the existing value is the default value or the value provided by the end user, returning the existing value to the remote client computing device in a response. The code is executable by the firmware to, in response to determining that the existing value is the value provided by the prior end user, refusing to return the existing value by returning a different response to the remote client computing device, the different response not including the existing value.

An example system includes hardware components and software components having configuration parameters. The system includes a non-transitory computer-readable data storage medium to store guest private keys that are selectively enabled to permit changes to the configuration parameters by different end users. The system includes firmware. The firmware is to receive a request to change a selected configuration parameter of the configuration parameters, from a remote client computing device operated by a selected end user. The request is encrypted or signed with a guest public key. The firmware is to determine whether the guest public key matches a currently enabled guest private key of the guest private keys. The firmware is to, in response to determining that the guest public key matches the currently enabled guest private key, determine whether the request provides complete data to change the selected configuration parameter. The firmware is to, in response to determining that the request provides the complete data to change the selected configuration parameter, change the selected configuration parameter in accordance with the request.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of an example system including a computing device, a host remote client computing device, and one or more end user remote client computing devices.

FIG. 2 is a flowchart of an example method for host user management of a computing device.

FIG. 3 is a flowchart of an example method for end user access to a computing device.

FIGS. 4, 5, and 6 are flowcharts of example methods by which an end user can be permitted to make configuration changes to a computing device.

FIG. 7 is a diagram of an example computing device.

FIG. 8 is a diagram of an example implementation of the methods of FIGS. 2 and 3.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the embodiment of the invention is defined only by the appended claims.

As noted in the background section, cloud computing topologies such as infrastructure as a service (IaaS) and platform as a service (PaaS) permit organizations like companies to lease or rent computing devices, such as servers, which remain physically located at the facilities of service providers. When a company or other customer rents a server, for instance, the service provider provides the company with access to the server over the Internet, for the company's exclusive use. When the company no longer requires the server, days, weeks, or even months later, the service provider can then provide a different customer exclusive access to the server.

However, security becomes an issue as to customer data, such as customer-specific configuration settings, remaining on the server when a customer has finished using the server. The next customer may find that the previous customer's data is still on the server. Resetting the server to a default state is difficult to achieve. For example, performing various “reset to defaults” functions available on a server generally does not change the version of firmware of the server. More problematic is that residual customer data, even if cleared or erased, may still in fact be stored on the server. As such, some companies are reluctant to use cloud computing services due to the potential security risk.

Techniques disclosed herein overcome these existing shortcomings. A selected guest key is activated. The guest key is for making configuration changes to the computing device in a current use period of the computing device by an end user to which the key has been provided. The end user presents the selected guest key when remotely logging onto the computing device from a remote client device, and is authenticated via this guest key. The end user is then permitted to make configuration changes to the computing device from the remote client device. The configuration changes are encrypted or signed with the selected guest key. When the current use period of the computing device has expired, the selected guest key is deactivated, and a different selected guest key, for a different end user, can be activated.

When an end user makes a request to retrieve an existing value for a configuration parameter of the computing device, firmware of the device determines whether the existing value is a default value, a value that the end user provided previously, or a value that was provided by a prior end user in a prior use period of the computing device. The end user is permitted to retrieve and thus view the parameter's existing value just if the user previously provided it, or if the value is a default value. If the existing value of the parameter was provided by a prior end user in a prior use period of the computing device, the current end user is not permitted to retrieve the value.

Furthermore, when an end user makes a request to change a configuration parameter of the computing device, firmware of the device determines whether the request provides all the data needed to change the parameter. If so, the firmware changes the parameter in accordance with the request. If not, the firmware may prompt the end user to provide the remainder of the data needed to change the parameter, or use default data for the remainder of the data. As such, the end user cannot nefariously make incomplete configuration parameter change requests in an attempt to “sniff out” the configuration parameter values of a prior end user.

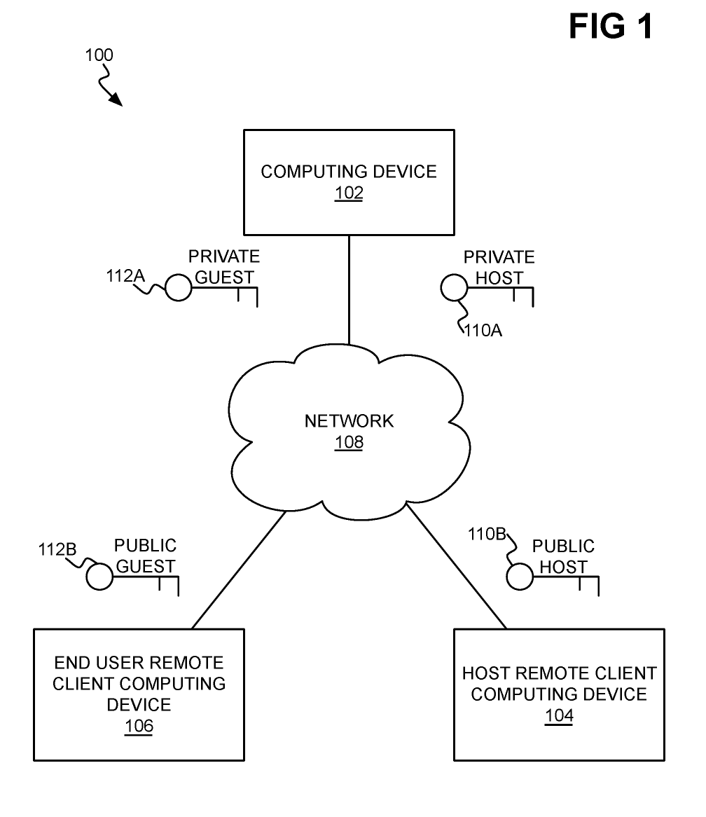

FIG. 1 shows an example system 100. The system 100 includes a computing device 102, such as a server computing device. The computing device 102 can be operated by a service provider that leases or rents the device 102 to clients or customers, which are referred to as end users. The computing device 102 physically remains at a location under the control or management of the service provider. When an end user leases the computing device 102, the service provider gives the end user electronic access to the device 102, but generally does not provide the end user with physical access to the device 102. In general, when an end user leases the computing device 102, the end user receives exclusive access to the device 102 during the lease or rental period, which is referred to as a use period herein. That is, the end user generally has exclusive access to the computing device 102, as opposed to shared access with other end users (i.e., other customers or clients of the service provider).

An end user in this instance can be a corporation, company, or other type of organization. The configuration changes described herein are typically made by an administrator user of such a corporation or company that is leasing or renting the computing device 102. The administrator user may in turn authorize other users to use the computing device 102, but such other users typically do not make configuration changes to the device 102, such as those described herein.

The system 100 includes a host remote client computing device 104, which is the remote client computing device 104 that a host user, such as the service provider, uses to remotely access the computing device 102. Similarly, the system 100 includes an end user remote client computing device 106 that an end user, such as a client or customer of the service provider, uses to remotely access the computing device 102. The remote client computing devices 104 and 106 access the computing device 102 over a network 108, which may be or include the Internet, intranets, extranets, wide-area networks (WANs), local-area networks (LANs), mobile data networks, wired networks, wireless networks, and so on. Examples of the client computing devices 104 and 106 include desktop and laptop computers, tablet computing devices, and smartphones.

A private host key 110A and a public host key 110B are together referred to as a pair of host keys 110. The private host key 110A remains on the computing device 102. The public host key 110B can be stored on the host remote client computing device 104. When the host user is to access the computing device 102, the host user transmits the public host key 110B from the client computing device 104 to the computing device 102 over the network 108. The computing device 102 authenticates the public host key 110B against the private host key 110A. The host user is permitted to manage the computing device 102 using the public host key 110B, as described later in the detailed description. The client computing device 104 can encrypt or sign communications transmitted through the network 108 to the computing device 102 using the public host key 110B, which the computing device 102 decrypts using the private host key 110A.

A private guest key 112A and a public guest key 112B are together referred to as a pair of guest keys 112. The private guest key 112A is stored on the computing device 102, and the public guest key 112B can be stored on the end user remote client computing device 106. When the end user is to access the computing device 102, the end user transmits the public guest key 112B from the client computing device 106 to the computing device 102 over the network 108. The computing device 102 authenticates the public guest key 112B against the private guest key 112A. The end user is permitted to use the computing device 102, including making configuration changes to the device 102, by using the public guest key 112B, as described later in the detailed description. The client computing device 106 can encrypt or sign communications transmitted through the network 108 to the computing device 102 using the public guest key 112B, which the computing device 102 decrypts using the private guest key 112A.

In general, there are multiple pairs of guest keys 112. Each pair corresponds to a different end user. An end user may transfer its public guest key 112B between different remote client computing devices 106, and may copy and store the public key 112B on multiple such devices 106. At any given time, just one pair of guest keys 112 may be activated and enabled, so that the end user corresponding to this guest key pair has exclusive access to the computing device 102. The other pairs of guest keys 112 are thus deactivated and disabled.

There may just be one pair of host keys 110. The host user may similarly transfer its public host key 110A between different host remote client computing devices 104, and may copy and store the public key 110B on multiple such devices 104. The host user accesses the computing device 102 using the public host key 110B to manage the pairs of guest keys 112, whereas an end user access the computing device 102 using its public guest key 112B to use the device 102. A pair of keys, including a public key and a private key, is a cryptographic system. Any user can encrypt data using a public key, but the data can be encrypted just by the private key.

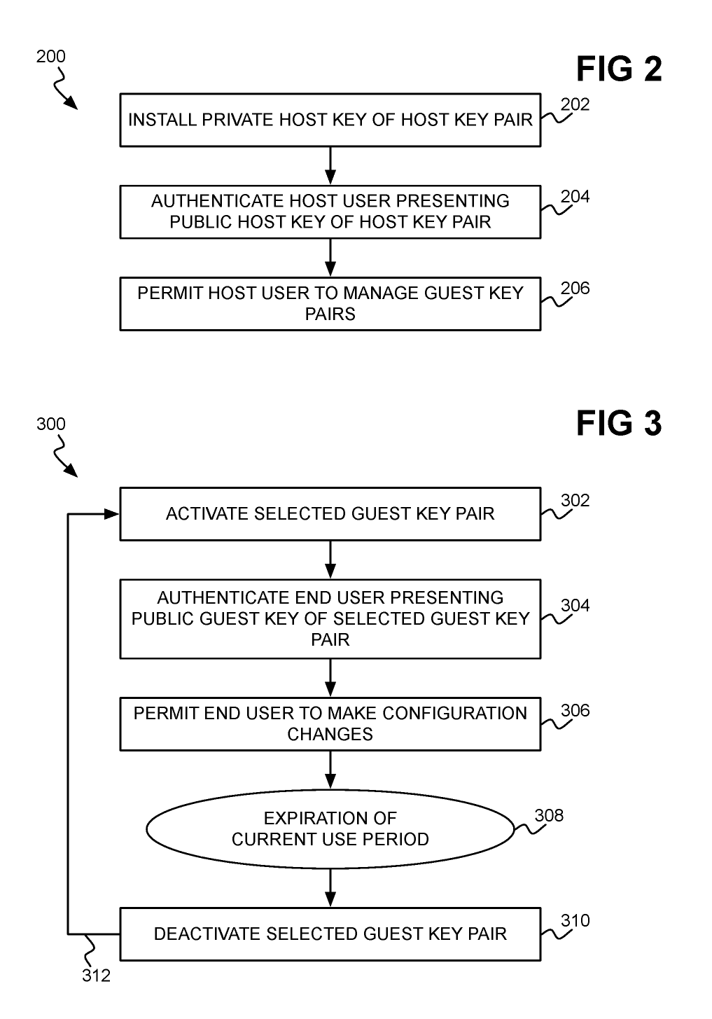

FIG. 2 shows an example method 200 for host user management of the computing device 102. The method 200 may be performed by the computing device 102. For example, the method 200 may be implemented as computer-executable code stored on a non-transitory computer-readable data storage medium that is executed by a processor of the computing device 102. In particular, the processor may be that of a service processor, such as a baseboard management controller (BMC), and may be the firmware of the service processor or BMC. The computing device 102 installs, or stores, the private host key 110A of the pair of host keys 110 (202). For instance, the host user when initially setting up the computing device 102 may transfer the private host key 110A to the computing device 102 for installation thereon.

Thereafter, the host user can remotely log onto the computing device 102, from the host remote client computing device 104 over the network 108, using the public host key 110B. As such, the computing device 102 authenticates the host user presenting the public host key 110B (204), using the private host key 110A. That is, the computing device 102 determines that the public host key 110B that has been presented matches the private host key 110A. Responsive to successful authentication, the computing device 102 permits the host user to manage the pairs of guest keys 112 (206), via communication from the host remote client computing device 104 over the network 108 that is encrypted or signed with the public host key 110B. For instance, the host user can activate or enable, deactivate or disable, generate and/or install, and remove or delete any pair of guest keys 112 in relation to the computing device 102.

When a new end user is to receive access to the computing device 102 at any point in the future, a new pair of guest keys 112 may be generated. The new private guest key 112A is stored on the computing device 102, and the new public guest key 112B transmitted to the end user. When an end user for which a pair of guest keys 112 has already been generated is to receive access to the computing device 102, the pair of guest keys 112 for this end user is activated or enabled. Therefore, when the end user attempts to remotely log onto the computing device 102 and presents the public guest key 112B, the device 102 grants access after authenticating the public guest key 112B against the private guest key 112A because the pair of guest keys 112 has been enabled.

When an existing end user is no longer to receive access to the computing device 102 at any point in the future, the private guest key 112A of the pair of guest keys 112 for this user is removed from the computing device 102. Even though the end user may retain the public guest key 112B, because the private guest key 112A is no longer stored on the computing device 102, the device 102 cannot authenticate the end user and thus cannot provide access to the end user. When an end user that currently has access to the computing device 102 is to no longer have access—but which may have access again in the future—the pair of guest keys 112 for this end user is deactivated or disabled. When the end user subsequently attempts to remotely log onto the computing device 102, the computing device 102 does not grant access because the pair of guest keys 112 has been disabled.

FIG. 3 shows an example method 300 for end user access to the computing device 102. The method 300 may be performed by the computing device 102 as described above in relation to the method 200. The computing device 102, via the host user, for instance, remotely accessing the device 102 using the public host key 110B, first activates a selected pair of guest keys 112, which is the pair of guest keys corresponding to the end user to which access to the device 102 is to be provided (302). Thereafter, the end user in question can remotely log onto the computing device 102, from the end user remote client computing device 106 over the network 108, using the public guest key 112B. As such, the computing device 102 authenticates the end user presenting the public guest key 112B (304), using the private guest key 112A that has been enabled. That is, the computing device 102 determines that the selected public guest key 112B that has been presented matches the private guest key 112A that has been enabled.

Responsive to authentication of the end user, the computing device 102 permits end user to make configuration changes to the computing device 102 (306), via communication from the end user remote client computing device 106 over the network 108 that is encrypted or signed with the public guest key 112B. Examples by which such configuration changes are permitted to be made are described later in the detailed description. Each time a configuration change is made, the computing device 102 may track that the current end user has made the change, as opposed to a prior end user in a prior use period of the computing device 102, and as opposed to the change being made as resulting from a reset to defaults command issued on the computing device 102.

At the time the selected pair of guest keys 112 is activated in part 302, it is said that a new current use period of the computing device 102 commences by the user to which this pair of guest keys 112 corresponds. The current use period lasts while the pair of guest keys 112 is enabled. Therefore, during the current use period, the end user may remotely log on and subsequently log off the computing device 102 multiple times to make configuration changes to the device 102. The current use period may last days or even weeks or months, and can correspond to the length of time for which the end user has rented or leased exclusive access to the computing device 102.

Once the current user period has expired (308), however, the end user is no longer permitted to access the computing device 102. Therefore, the selected pair of guest keys 112 corresponding to the end user is deactivated or disabled (310). For instance, the host user may use the public host key 110B to log onto the computing device 102 from the host remote client computing device 104 to disable the selected pair of guest keys 112, or the deactivation process may be automated. When no end user has access to the computing device 102, at some point thereafter the method 300 may be repeated for a different end user having a different pair of guest keys 112 (312).

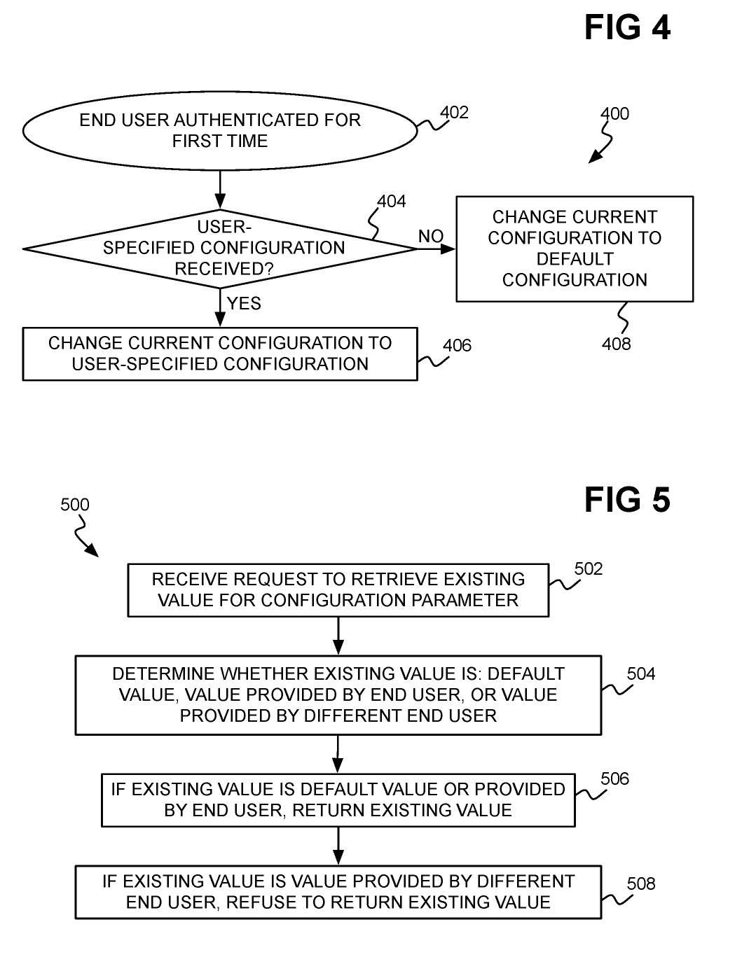

FIGS. 4, 5, and 6 show example methods 400, 500, and 600, respectively, as to how the user can make configuration changes to the computing device 102 after authentication, such as in part 306 of the method 300. The methods 400, 500, and 600 can each be performed by the computing device 102. The methods 400, 500, and 600 can each be implemented as has been described above in relation to the method 200.

In FIG. 4, when the end user is authenticated for the first time (402), the end user may or may not provide a user-specified configuration for the computing device 102. If the computing device 102 receives a user-specified configuration (404), such as from the end user remote client computing device 106 and as encrypted or signed by the private guest key 112B, then the current configuration of the computing device 102 is changed to the user-specified configuration (406). However, if the computing device 102 does not receive a user-specified configuration (404), then the current configuration of the computing device 102 may be changed to a default configuration (408), which may be pre-specified by the host user, for instance.

The configuration of the computing device 102 in the method 300 can include a firmware version of the computing device 102. For instance, some computing devices can have multiple versions of firmware. While generally it may be desirable to use the most recent firmware version, some usage scenarios, such as some software applications, that the end user may want to run on the computing device 102 may not be compatible with the most recent firmware version. Therefore, in these and other cases, the user can specify an older firmware version, to ensure compatibility.

The configuration of the computing device 102 in the method 300 can include values for multiple configuration parameters of the device 102. The user-specified configuration may provide values for every configuration parameter of the computing device 102, or just a subset of the configuration parameters of the device 102. Configuration parameters can include a list of authorized users of the computing device 102 that are permitted to use the device 102 during the current use period. Configuration parameters can include network settings, storage settings, and other types of configuration parameters as well. In general, the configuration parameters include those parameters of the computing device 102 that an administrator user of a company, corporation, or other organization or entity makes when first setting up the computing device 102, such that other users of this organization or entity can then use the device 102 to perform tasks and workloads in satisfaction of their job duties.

In FIG. 5, the computing device 102 receives a request from the end user, such as via the end user remote client computing device 106, to retrieve the existing value for a particular configuration parameter of the device 102 (502). The computing device 102 determines whether the existing value is the default value for the parameter, a value that the end user in question previously provided and thus to which the end user previously changed the parameter, or a value that a prior end user previously provided and thus to which a different end user changed the parameter, such as in a prior use period (504). If the existing value is the default value for the parameter, or a value that the end user in question previously provided, then the computing device 102 returns the existing value to the end user remote client computing device 106 (506).

However, if the existing value is a value that a different end user having a different guest key provided in a different (prior) use period of the computing device 102, then the device 102 refuses to return the existing value to the remote client computing device 106 (508). That is, a different response is returned to the remote client computing device 106, which does not include the existing value. The request made in part 502 may be encrypted or signed by the public guest key 112B.

Permitting the current end user to retrieve and thus to view the existing value of a configuration parameter of the computing device 102 just if the existing value is a default value or is a value to which this end user changed the parameter ensures that a nefarious end user cannot employ “sniffing” and other techniques in an attempt to guess a value to which a prior end user changed the configuration parameter. As such, the current end user is more likely to trust and thus to use the computing device 102 even in relation to highly confidential data, because the end user can rest assured that when the current use period of the device 102 ends, a future end user in a future use period of the device 102 will not be permitted to view the custom values to which the current end user has changed the parameters of the device 102. Although resetting the current configuration of the computing device 102 to a default configuration in part 408 of the method 400 should, for instance, overwrite all such custom values in theory, in some situations it does not, and therefore the method 500 provides a modicum of extra security.

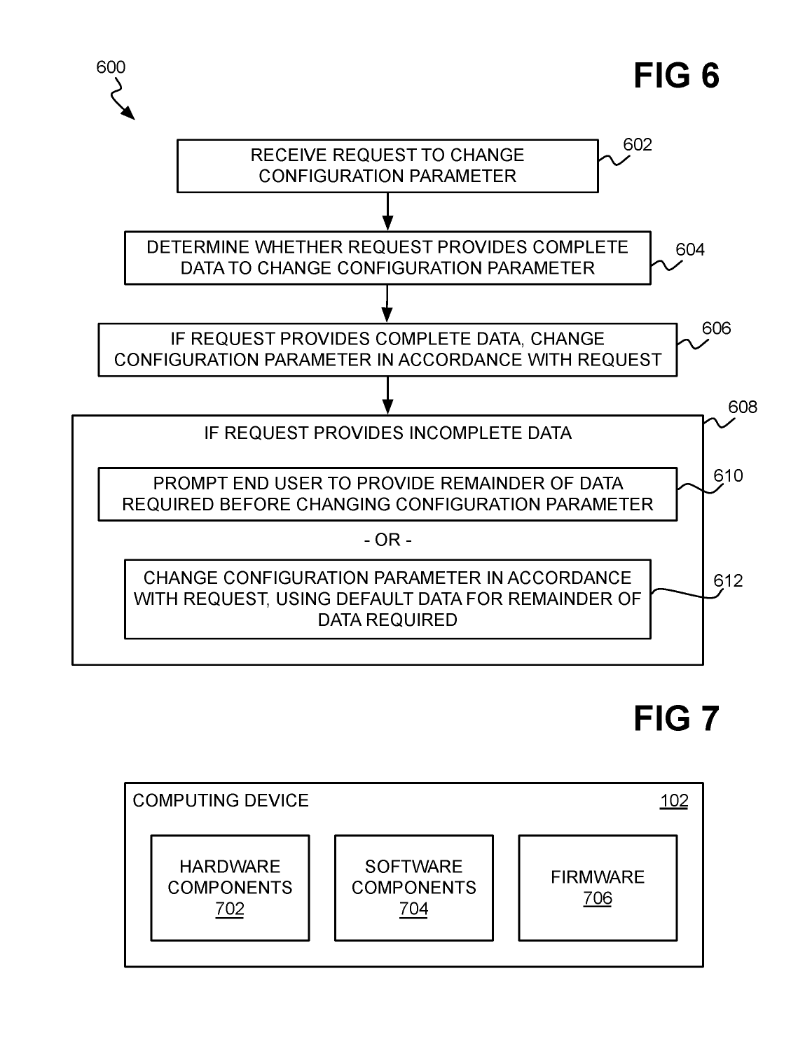

In FIG. 6, the computing device 102 receives a request from the end user, such as via the end user remote client computing device 106, to change a particular configuration parameter of the device 102 (602). The computing device 102 determines whether the request provides complete data to change the configuration parameter in question (604). If the request does provide all the data needed to change the configuration parameter, then the computing device 102 can change the parameter solely in accordance with the request (606). However, if the request does not provided all the data necessary to change the configuration parameter, then the computing device 102 may do one of two things (608). First, the computing device 102 may prompt the end user to provide the remainder of the data needed to change the configuration parameter, and thus change the parameter in accordance with the request in combination with the subsequently provided additional data (610). Second, the computing device 102 may change the configuration parameter in accordance with the request, but use default data for the remainder of the data required to change the parameter that was not provided in the request (612). The request made in part 602 and the additional data provided in part 610 may be signed or encrypted by the public guest key 112B.

The method 600 provides additional security to end user data of the computing device 102. As a concrete example, some types of network parameters of the computing device 102 may require multiple pieces of data. A nefarious end user may attempt to “sniff out” a prior end user's settings for these parameters by providing incomplete data in a request to change the parameters. If the computing device 102 were to overwrite just the settings for which data was provided, then the current end user may be able to retrieve the prior end user's settings for which the current end user did not provide any data. For example, such a configuration parameter may be considered as having been changed by the current end user in part 504 of the method 500, such that the existing value (the prior end user's settings) retrieved and returned in part 506. By not changing such a configuration parameter unless the current end user provides complete data—either initially in part 602 or over parts 602 and 610—or by changing the configuration parameter in accordance the currently received request as well as by filling in any missing data with default data in part 612, another layer of security is provided.

FIG. 7 shows an example implementation of the computing device 102. The computing device 102 includes hardware components 702 and software components 704. The hardware components 702 can include network adapters, storage devices, memory, processors, graphics adapters, and other hardware. The software components 704 can include operating systems and application programs. The components 702 and 704 have configuration parameters that can be set in conjunction with the methods that have been described. As such, the computing device 102 includes firmware 706, which may or may not be part of a service processor or BMC, and which performs the methods that have been described to set the configuration parameters of the components 702 and 704.

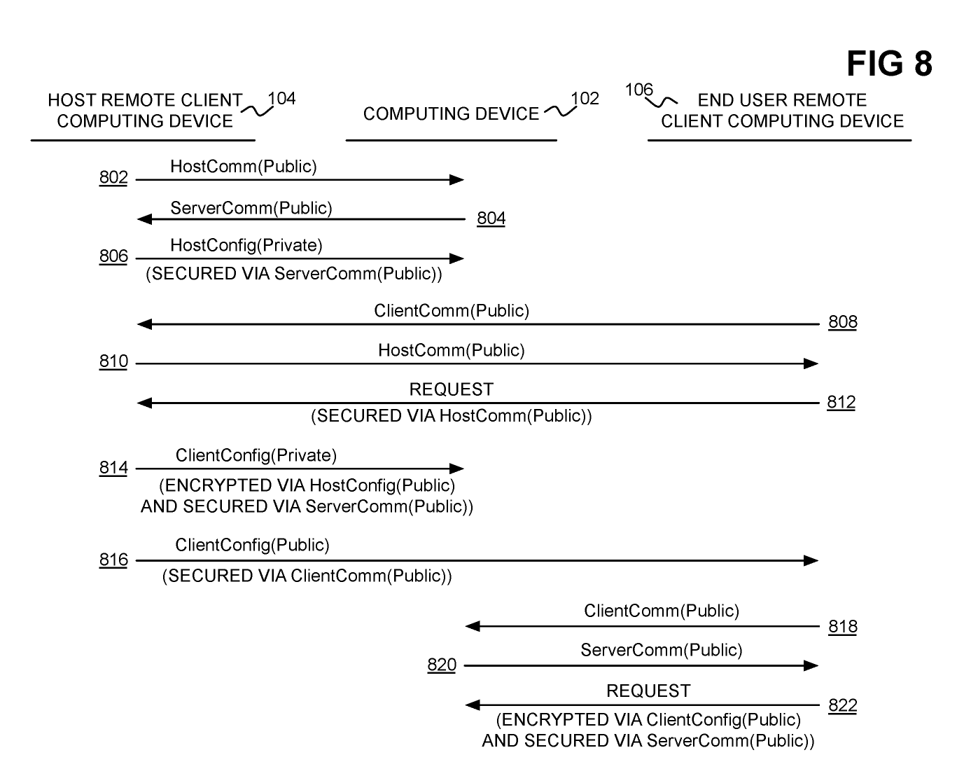

FIG. 8 shows an example implementation of the methods 200 and 300 of FIGS. 2 and 3, respectively, which is more detailed and uses layers of cryptographic keys to secure communications among the computing device 102, the host remote client computing device 104, and the end user remote client computing device 106. There are both communication keys and configuration keys in the implementation of FIG. 8, which are used in a layered manner. The communication keys include a pair of host communication keys, including HostComm(Public) and HostComm(Private). The former is a public key and the latter is a private key. The communication keys include a pair of server communication keys, including ServerComm(Public) and ServerComm(Private), which are public and private keys, respectively. The communication keys include a pair of client communication keys, including ClientComm(Public) and ClientComm(Private), which are public and private keys, respectively.

The configuration keys include a pair of host configuration keys, including HostConfig(Private) and HostConfig(Public). The former and latter keys are private and public keys respectively, and correspond to the private host key 110A and the public host key 110B that have been described. The configuration keys include a pair of client configuration keys, including ClientConfig(Private) and ClientConfig(Public), which are private and public keys, respectively, and which correspond to the private guest key 112A and the public guest key 112B that have been described. The client configuration keys are used by the end user remote client computing device 106 to make configuration changes on the computing device 102, and the host configuration keys are used by the host remote client computing device 104 to manage the client configuration keys on the computing device 102. Such encrypted change requests and management requests are secured within communications that are themselves encrypted with the communication keys.

The host remote client computing device 104 stores HostComm(Private), and does not share this private key; likewise, the computing device 102 stores ServerComm(Private), and does not share this private key. The computing devices 104 and 102 exchange their respective public keys over unencrypted communication, with the host remote client computing device 104 providing the computing device 102 with HostComm(Public) (802), and the computing device 102 providing the host remote client computing device 104 with ServerComm(Public) (804). The host remote client computing device 104 generates the pair of host configuration keys, and transmits HostConfig(Private) to the computing device 102 (806), which stores this private key. The transmission of HostConfig(Private) from the host remote client computing device 104 to the computing device 102 is secured, such as via being encrypted, using ServerComm(Public), which the computing device 102 decrypts via ServerComm(Private). (Responses from the computing device 102 back to the host remote client computing device 104 are secured, such as via being encrypted, using HostComm(Public), which the host remote client computing device 104 decrypts via HostComm(Private).)

The end user remote client computing device 106 stores ClientComm(Private), and does not share this private key. The end user remote client computing device 106 and the host remote client computing device 104 exchange their respective public keys over unencrypted communication, with the end user remote client computing device 106 providing the host remote client computing device 104 with ClientComm(Public) (808), and the computing device 104 providing the computing device 106 with HostComm(Public) (810). The end user remote client computing device 106 then issues a request to the host remote client computing device 104 to receive access to the computing device 102 (812). This request is secured, such by being encrypted, via HostComm(Public), which the host remote client computing device 104 decrypts using HostComm(Private). (Responses from the host remote client computing device 104 are secured, such as via being encrypted, using ClientComm(Public), which the end user remote client computing device 106 decrypts via ClientComm(Private).)

In response to receiving this request, the host remote client computing device 104 generates the pair of client configuration keys, and transmits ClientConfig(Private) to the computing device 102 (814), which stores this private key. ClientConfig(Private) is encrypted using HostConfig(Public), and the entire communication is secured, such as via being encrypted, using ServerComm(Public). The computing device 102 decrypts the entire communication using ServerComm(Private), which yields the encrypted ClientConfig(Private), and then the computing device 102 decrypts ClientConfig(Private) using HostConfig(Private). In this way, there is layered security, using both a host configuration key and a server communication key. The host remote client computing device 104 also transmits ClientConfig(Public) to the end user remote client computing device 106 (816), which stores this public key. ClientConfig(Private) is secured, such as via being encrypted, using ClientComm(Public), which the end user remote client computing device 106 decrypts using ClientComm(Private).

The end user remote client computing device 106 and the computing device 102 exchange their respective public keys over unencrypted communication, with the end user remote client computing device 106 providing the computing device 102 with ClientComm(Public) (818), and the computing device 102 providing the end user remote client computing device 106 with ServerComm(Public) (820). The end user remote client computing device 106 can now issue a configuration change request to the computing device 102 (822). The request is encrypted using ClientConfig(Public), and the entire communication is secured, such as via being encrypted, using ServerComm(Public). The computing device 102 decrypts the entire communication using ServerComm(Private), which yields the encrypted request, and the computing device 102 decrypts the request using ClientConfig(Private). In this way, there is layered security, using both a client configuration key and a server communication key. (Responses from the computing device 102 are secured, such as via being encrypted, using ClientComm(Public), which the end user remote client computing device 106 decrypts via ClientComm(Private).)

The layered cryptographic key approach of FIG. 8 provides additional security beyond typical public-private key cryptography, and novelly employs configuration cryptographic key pairs in addition to communication cryptographic key pairs. Besides the usage of communication cryptographic key pairs, in other words, the approach of FIG. 8 employs configuration cryptographic key pairs to provide additional security. ClientConfig(Private) itself is encrypted via HostConfig(Public) and then sent in a secured message that is encrypted via ServerComm(Public) in part 814. The configuration change request itself is encrypted via ClientConfig(Public) and then sent in a secured message that is encrypted via ServerComm(Public) in part 822.

The techniques that have been described herein provide for a secure manner by which configuration parameters of a computing device 102 that is leased or rented by an end user from a service provider can be viewed and changed. Guest keys, including public and private guest keys, and host keys, including public and private host keys, are employed for authentication of end users and host users, respectively, and thus for access to the computing device 102 by such users. Specific techniques for retrieving existing configuration parameter values and for changing configuration parameter values provide for additional security, particularly as to ensuring that a current end user cannot retrieve and view the parameter values set by a prior end user in a prior use period. As such, the viability of using computing devices managed by service providers increases, even when data security is paramount.

It is finally noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Examples of non-transitory computer-readable media include both volatile such media, like volatile semiconductor memories, as well as non-volatile such media, like non-volatile semiconductor memories and magnetic storage devices. It is manifestly intended that this invention be limited only by the claims and equivalents thereof.

We claim:

1. A method comprising:
activating, via firmware of a computing device, a selected guest key for making configuration changes to the computing device in a current use period of the computing device by an end user to which the selected guest key has been provided;
authenticating, via the firmware, the end user presenting the selected guest key when remotely logging onto the computing device from a remote client computing device; and
responsive to authentication of the end user, permitting, via the firmware, the end user to make the configuration changes to the computing device via communications from the remote client computing device that are encrypted or signed with the selected guest key.

2. The method of claim 1, wherein activating the selected guest key comprises enabling, by the firmware, a private guest key corresponding to the selected guest key, on the computing device, the selected guest key being a public guest key corresponding to the private guest key,
and wherein authenticating the end user comprises determining that the selected guest key presented matches the private guest key.

3. The method of claim 1, further comprising:
upon expiration of the current use period of the computing device, deactivating the selected guest key, via the firmware;
after deactivating the selected guest key, activating, via the firmware, a new selected guest key for making the configuration changes to the computing device in a new current use period of the computing device by a different end user to which the new selected guest key has been provided;
authenticating, via the firmware, the different end user presenting the new selected guest key when remotely logging onto the computing device from a different remote client computing device; and
response to authentication of the different end user, permitting, via the firmware, the different end user to make the configuration changes to the computing device via communications from the different remote client computing device that are encrypted or signed with the new selected guest key.

4. The method of claim 1, wherein permitting the end user to make the configuration changes comprises:
receiving a request to retrieve an existing value for a configuration parameter of the computing device, from the remote client computing device;
determining whether the existing value is one of: a default value for the configuration parameter, a value for the configuration parameter provided by the end user, and a value for the configuration parameter provided by a prior end user of the computing device via a different guest key within a prior use period of the computing device;
in response to determining that the existing value is the default value or the value provided by the end user, returning the existing value to the remote client computing device; and
in response to determining that the existing value is the value provided by the prior end user, refusing to return the existing value to the remote client computing device.

5. The method of claim 1, wherein permitting the user to make the configuration changes comprises:
receiving a request to change a configuration parameter of the computing device, from the remote client computing device;
determining whether the request provides complete data to change the configuration parameter; and
in response to determining that the request provides the complete data to change the configuration parameter, changing the configuration parameter in accordance with the request.

6. The method of claim 5, wherein permitting the end user to make the configuration change further comprises:
in response to determining that the request provides incomplete data to change the configuration parameter, prompting the end user to provide a remainder of data required to change the configuration parameter.

7. The method of claim 5, wherein permitting the end user to make the configuration change further comprises:
in response to determining that the request provides incomplete data to change the configuration parameter, changing the configuration parameter in accordance with the request by using default data for a remainder of data required to change the configuration parameter.

8. The method of claim 1, further comprising:
after authenticating the end user, receiving, by the firmware, a user-specified configuration of the computing device from the remote client computing device, the user-specified configuration encrypted or signed with the selected guest key;
changing, by the firmware, a current configuration of the computing device to the user-specified configuration.

9. The method of claim 1, further comprising:
after authentication the end user, changing, by the firmware, a current configuration of the computing device to a default configuration if no user-specified configuration of the computing device has been received by the firmware from the remote client computing device.

10. The method of claim 1, further comprising:
prior to permitting any end user to remotely log onto the computing device, installing, via the firmware, a private host key for managing guest keys, including the selected guest key, on the computing device;
authenticating, via the firmware, a host user presenting a public host key corresponding to the private host key when remotely logging onto the computing device from a different remote client computing device; and
responsive to authentication of the host user, permitting, via the firmware, the host user to activate, deactivate, install, and remove the guest keys in relation to the computing device via communications from the different remote client computing device that are encrypted or signed with the public host key.

11. A non-transitory computer-readable data storage medium storing computer-executable code executable by firmware of a computing device to:
receive a request to retrieve an existing value for a configuration parameter of the computing device from a remote client computing device operated by an end user, the request encrypted or signed with a guest public key;
determine whether the guest public key matches a currently enabled guest private key of a plurality of guest private keys installed on the computing device;
in response to determining that the guest public key matches the currently enabled guest private key, determine whether the existing value is one of: a default value for the configuration parameter, a value for the configuration parameter provided by the end user, and a value for the configuration parameter provided by a prior end user via a different guest public key matching a currently disabled guest private key of the plurality of guest private keys;
in response to determining that the existing value is the default value or the value provided by the end user, returning the existing value to the remote client computing device in a response; and
in response to determining that the existing value is the value provided by the prior end user, refusing to return the existing value by returning a different response to the remote client computing device, the different response not including the existing value.

12. The non-transitory computer-readable data storage medium of claim 11, wherein the request is a first request, the configuration parameter is a first configuration parameter, and wherein the computer-executable code is executable by the firmware to further:
receive a second request to change a second configuration parameter of the computing device, from the remote client computing device, the second request encrypted or signed with the guest public key;
determine whether the guest public key matches the currently enabled guest public key;
in response to determining that the guest public key matches the currently enabled guest private key, determine whether the second request provides complete data to change the second configuration parameter; and
in response to determining that the second request provides the complete data to change the second configuration parameter, change the second configuration parameter in accordance with the second request.

13. The non-transitory computer-readable medium of claim 12, wherein the computer-executable code is executable by the firmware to further:
in response to determining that the second request provides incomplete data to change the second configuration parameter, prompt the end user to provide a remainder of data required to change the second configuration parameter, in a response.

14. The non-transitory computer-readable medium of claim 12, wherein the computer-executable code is executable by the firmware to further:
in response to determining that the second request provides incomplete data to change the second configuration parameter, change the second configuration parameter in accordance with the second request by using default data for a remainder of data required to change the second configuration parameter.

15. A system comprising:
a plurality of hardware components and software components having a plurality of configuration parameters;
a non-transitory computer-readable data storage medium to store a plurality of guest private keys that are selectively enabled to permit changes to the configuration parameters by different end users; and
firmware to:
receive a request to change a selected configuration parameter of the plurality of configuration parameters, from a remote client computing device operated by a selected end user, the request encrypted or signed with a guest public key;
determine whether the guest public key matches a currently enabled guest private key of the plurality of guest private keys;
in response to determining that the guest public key matches the currently enabled guest private key, determine whether the request provides complete data to change the selected configuration parameter; and
in response to determining that the request provides the complete data to change the selected configuration parameter, change the selected configuration parameter in accordance with the request.

16. The system of claim 15, wherein the firmware is to further:
in response to determining that the request provides incomplete data to change the selected configuration parameter, prompt the selected end user to provide a remainder of data required to change the selected configuration parameter, in a response.

17. The system of claim 15, wherein the firmware is to further:
in response to determining that the request provides incomplete data to change the configuration parameter, change the selected configuration parameter in accordance with the request by using default data for a remainder of data required to change the configuration parameter.

18. The system of claim 15, wherein the request is a first request, the selected configuration parameter is a first selected configuration parameter, and wherein the firmware is to further:
receive a second request to retrieve an existing value for a second selected configuration parameter of the configuration parameters from the remote client computing device, the second request encrypted or signed with the guest public key;
determine whether the guest public key matches the currently enabled guest private key;
in response to determining that the guest public key matches the currently enabled guest private key, determine whether the existing value is one of: a default value for the second selected configuration parameter, a value for the second selected configuration parameter provided by the end user, and a value for the second selected configuration parameter provided by a prior end user via a different guest public key matching a currently disabled guest private key of the plurality of guest private keys;
in response to determining that the existing value is the default value or the value provided by the end user, returning the existing value to the remote client computing device in a response; and
in response to determining that the existing value is the value provided by the prior end user, refusing to return the existing value by returning a different response to the remote client computing device, the different response not including the existing value.
